(19) United States
(12) Patent Application Publication
(10) Pub. No.: US 2010/0007585 A1
(43) Pub. Date: Jan. 14, 2010

(54) PLASMA DISPLAY PANEL

(75) Inventor: Shinya Fujiwara, Kyoto (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/298,816

(22) PCT Filed: Mar. 26, 2008
(86) PCT No.: PCT/JP2008/000725

§ 371 Date: Oct. 28, 2008

(30) Foreign Application Priority Data
Mar. 27, 2007 (JP) 2007-080965

(51) Int. Cl. G09G 3/28

(52) U.S. Cl. 345/60

(57) ABSTRACT

The plasma display panel of the present invention is a PDP in consideration of environmental problem, capable of achieving a high reliability in high definition display, and further advanced in yield and productivity. The plasma display panel of the present invention is a plasma display panel manufactured by disposing a pair of substrates face to face having a dielectric layer at least at one side, and sealing the surrounding with a sealing member, in which the expansion coefficient of the pair of substrates is 60×10⁻⁷ to 75×10⁻⁷/° C., and the expansion coefficient of the sealing member is 45×10⁻⁷ to 63×10⁻⁷/° C.

### TECHNICAL FIELD

The present invention relates to a plasma display panel used in a display device or the like.

### BACKGROUND ART

The plasma display panel (PDP) can be enhanced in definition and increased in screen size, and 65-inch class television sets are commercially developed.

The PDP is basically composed of a front panel and a back panel. The front panel is composed of a glass substrate of sodium borosilicate glass formed by float method, a display electrode formed on one of its principal planes formed of striped transparent electrode and bus electrode, a dielectric layer covering this display electrode and functioning as capacitor, and a protective layer composed of magnesium oxide (MgO) formed on the dielectric layer. The bus electrode for forming the display electrode is formed of a pair of scan electrode and sustain electrode.

On the other hand, the back panel is composed of a glass substrate, a striped address electrode formed on one of its principal planes, a base dielectric layer for covering the address electrode, barrier ribs formed on the base dielectric layer, and phosphor layers between barrier ribs for emitting red light, green light, and blue light.

The front panel and the back panel are sealed hermetically face to face against each electrode forming side, by means of a sealing member applied on the surrounding, and a discharge space partitioned by the barrier ribs is packed with discharge gas of Ne—Xe at pressure of 54000 Pa to 80000 Pa. The PDP discharges by applying a video signal voltage selectively to the discharge electrode, and the ultraviolet ray generated by the discharge excites each color phosphor layer, and red light, green light, and blue light are emitted to realize a color image display.

The dielectric layer is formed of a low melting glass mainly made of lead oxide, and the sealing member is also a low melting glass mainly made of lead oxide. Owing to the recent concern about environmental problems, the dielectric layer is made of a material not containing lead component. Examples of sealing member of phosphoric material not containing lead component, and examples of sealing member of bismuth oxide are disclosed in patent document 1 and patent document 2 (see, for example, patent document 1, patent document 2).

Since the PDP can be enhanced in definition and increased in screen size, 65-inch class television sets are commercially developed. Recently, the PDP is making a progress into the system of high definition television having the number of scanning lines more than two times that of the existing NTSC system, and the lead-free PDP is also demanded in consideration of the environmental problems.

However, when the sealing member mainly composed of low melting glass of phosphoric acid-tin oxide system not containing lead is used, the resistance to water is inferior as compared with the lead oxide system sealing member, and the air tightness of the PDP cannot be assured sufficiently.

In the conventional sealing member mainly composed of glass of bismuth oxide system, in the sealing process, the silver material of display electrode formed on the front panel, or address electrode formed on the back panel reacts with bismuth oxide, and lots of bubbles are generated, and the air tightness of the PDP cannot be assured sufficiently. This problem is more serious in the high definition PDP or other high definition television having more than two times of the scanning lines because the number of electrodes is increased.

The prior art had another problem in the glass substrate. In the conventional PDP manufacturing process, heat treatment process at 500 to 600° C. is repeated several times, and the glass substrate shrinks and expands by heat treatment owing to the properties of the glass substrate, and it is hard to maintain the dimensional precision.

In the heat treatment process, generally, a continuous baking oven is used, and a setter is used for enhancing the heat efficiency in PDP transfer in the oven, and the glass substrate is put on the setter. In this process, however, the glass substrate elongates and contracts in the units of several millimeters, and friction occurs between the glass substrate and the setter, and the surface of the glass substrate may be damaged, and the display quality may be inferior.

Also in the heat treatment process for forming a structural member such as dielectric layer or barrier rib on the front panel and back panel substrates, a residual distortion occurs due to difference in coefficient of thermal expansion between the substrates and the structural members, and the panels may be broken, and the manufacturing yield may be lowered. As the countermeasure, if attempted to increase the number of productions, there is a limit in increasing the processing speed of heat treatment process, and the number of productions cannot be increased.

In the prior art, there is also a serious problem in driving operation for displaying the image. In the AC type PDP, in its driving operation, pulse voltages are alternately applied to the scan electrode and the sustain electrode, and discharge is generated by the electric field occurring between the surface of the protective layer by way of dielectric layer on the scan electrode and the surface of the protective layer by way of dielectric layer on the sustain electrode. When voltages are thus applied alternately, a charging and discharging current not contributing to discharge luminescence flow due to capacity components of the dielectric layer, and it becomes a reactive current, and the power consumption increases, and it is hard to improve the efficiency.
Patent document 1: Unexamined Japanese Patent Publication No. 2004-182584
Patent document 2: Unexamined Japanese Patent Publication No. 2003-095697

### DISCLOSURE OF THE INVENTION

The present invention has solved the problems of the prior art, and presents a PDP in consideration of environmental problems, capable of achieving a high reliability in high definition display, and further advanced in yield and productivity.

The plasma display panel includes a pair of substrates disposed face to face and having a dielectric layer at least at one side, and sealing their surroundings with a sealing member, in which the expansion coefficient of the pair of substrates is 60×10⁻⁷ to 75×10⁻⁷/° C., and the expansion coefficient of the sealing member is 45×10⁻⁷ to 63×10⁻⁷/° C.

The plasma display panel includes a pair of substrates disposed face to face and having a dielectric layer at least at one side, and sealing their surroundings with a sealing member, in which the dielectric constant of the pair of substrates is 5.7 to 7.0, and the expansion coefficient of the sealing member is 45×10⁻⁷ to 63×10⁻⁷/° C.

The plasma display panel includes a pair of substrates disposed face to face and having a dielectric layer at least at one side, and sealing their surroundings with a sealing member, in which the distortion point of the pair of substrates is 600° C. or more, and the expansion coefficient of the sealing member is 45×10⁻⁷ to 63×10⁻⁷/° C.

### BRIEF DESCRIPTION OF THE DRAWINGS

FIG. 1 is a perspective view showing a structure of PDP in a preferred embodiment of the present invention.

FIG. 2 is a sectional view of a front panel of the PDP.

FIG. 3A is a plan view showing a sealed and bonded state of front panel and back panel of the PDP.

FIG. 3B is a sectional view showing a sealed and bonded state of front panel and back panel of the PDP.

FIG. 4 is a diagram showing the relation between expansion coefficient of glass substrate and shrinkage amount of substrate.

FIG. 5 is a diagram showing the relation between distortion point of glass substrate and shrinkage amount of substrate.

### DESCRIPTION OF THE REFERENCE NUMERALS AND SIGNS

1 PDP
2 Front panel
3 Front glass substrate
4 Scan electrode
4a, 5a Transparent electrode
4b, 5b Metal bus electrode
5 Sustain electrode
6 Display electrode
7 Black stripe (light shielding layer)
8 Dielectric layer
9 Protective layer
10 Back panel
11 Back glass substrate
12 Address electrode
13 Base dielectric layer
14 Barrier rib
15 Phosphor layer
16 Discharge space
50 Sealing member
51 Exhaust tube
52 Frit tablet
81 First dielectric layer
82 Second dielectric layer

### DETAILED DESCRIPTION OF THE PREFERRED EMBODIMENTS

A PDP in a preferred embodiment of the present invention is specifically described below while referring to the accompanying drawing.

### Preferred Embodiment

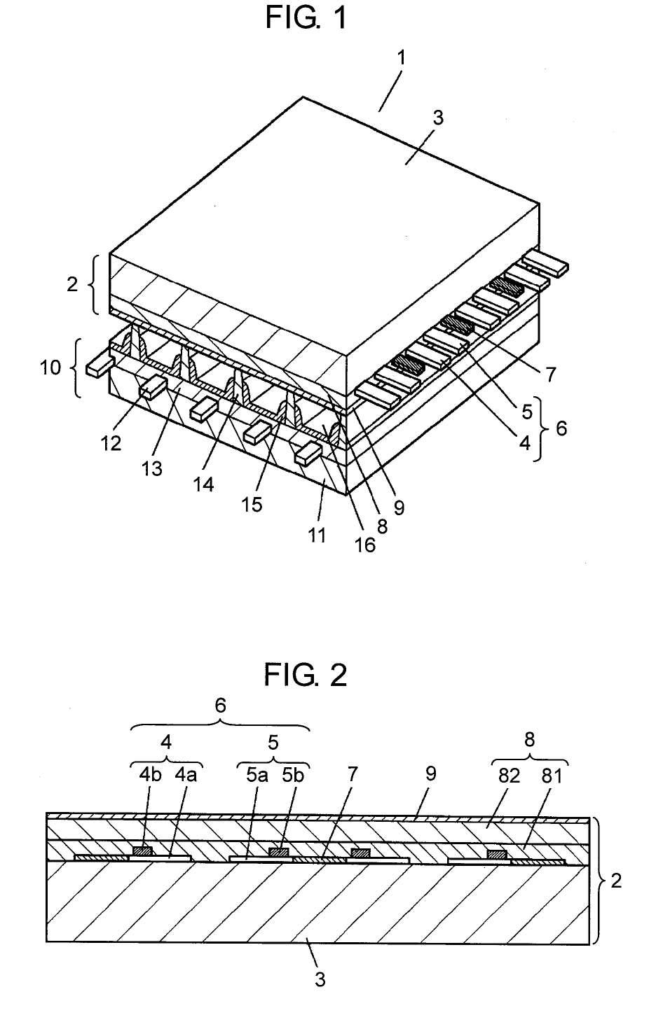

FIG. 1 is a perspective view showing a structure of PDP in a preferred embodiment of the present invention. A basic structure of the PDP is same as in a general alternating-current surface discharge type PDP. As shown in FIG. 1, PDP 1 includes front panel 2 formed of front glass substrate 3 and others, and back panel 10 formed of back glass substrate 11 and others, facing each other, and the surrounding is hermetically sealed with a sealing member such as glass frit. Sealed discharge space 16 in PDP 1 is packed with discharge gas such as neon (Ne) or xenon (Xe) at pressure of 54000 Pa to 80000 Pa.

On front glass substrate 3 of front panel 2, a pair of band-like display electrode 6 and black stripe (light shielding layer) 7 formed of scan electrode 4 and sustain electrode 5 are disposed parallel to each other in plural rows. On front glass substrate 3, dielectric layer 8 functioning as capacitor is formed so as to cover display electrode 6 and light shielding layer 7, and protective layer 9 formed of magnesium oxide (MgO) or the like is formed further on the surface.

On back glass substrate 11 of back panel 10, a plurality of band-like address electrodes 12 are disposed parallel to each other in a direction orthogonal to scan electrode 4 and sustain electrode 5 of front panel 2, and they are covered with base dielectric layer 13. Barrier ribs 14 of specified height for partitioning discharge space 16 are formed on base dielectric layer 13 between address electrodes 12. In the groove between barrier ribs 14, phosphor walls 15 for emitting red light, blue light, and green light by ultraviolet rays are sequentially applied and formed in every address electrode 12. Discharge cells are formed at intersecting positions of scan electrodes 4, sustain electrodes 5, and address electrodes 12, and discharge cells having red, blue and green phosphor layers 15 arranged in the direction of display electrodes 6 are pixels for color display.

FIG. 2 is a sectional view of front panel 2 of the PDP in the preferred embodiment of the present invention. FIG. 2 is a view inverted up and down from FIG. 1. As shown in FIG. 2, display electrode 6 and black stripe 7 formed of scan electrode 4 and sustain electrode 5 are patterned and formed on front glass substrate 3 manufactured by float method or the like. Scan electrode 4 and sustain electrode 5 are respectively composed of transparent electrodes 4a, 5a formed of indium tin oxide (ITO) or tin oxide (SnO₂), and metal bus electrodes 4b, 5b formed on transparent electrodes 4a, 5a. Metal bus electrodes 4b, 5b are used for the purpose of providing with conductivity in the longitudinal direction of transparent electrodes 4a, 5a, and are formed of conductive materials mainly composed of silver (Ag) material.

Dielectric layer 8 is formed of at least two layers, first dielectric layer 81 disposed to cover these transparent electrodes 4a, 5a, metal bus electrodes 4b, 5b, and black stripe 7 formed on front glass substrate 3, and second dielectric layer 82 formed on first dielectric layer 81. Protective layer 9 is formed on second dielectric layer 82.

Next, a manufacturing method of PDP is explained. First of all, scan electrode 4, sustain electrode 5, and light shielding layer 6 are formed on front glass substrate 3. Transparent electrodes 4a, 5a, and metal bus electrodes 4b,5b are patterned and formed by a method of photolithography or the like. Transparent electrodes 4a, 5a are formed by thin film process or the like, and metal bus electrodes 4b,5b are solidified by baking a paste containing silver (Ag) material at specified temperature. Light shielding layer 7 is similarly formed by screen printing method of a paste containing black pigment or by applying a black pigment on the entire surface of glass substrate, and patterning by photolithography and baking.

A dielectric paste layer (dielectric material layer) is formed applying a dielectric paste on front glass substrate 3 so as to cover scan electrode 4, sustain electrode 5, and light shielding layer 7 by die-coating method. After application of dielectric paste, by letting stand for a specified time, the surface of the applied dielectric paste layer is leveled and flattened. Later, the dielectric paste layer is baked and solidified, and dielectric layer 8 for covering scan electrode 4, sustain electrode 5, and light shielding layer 7 is formed. The dielectric paste is a paint containing glass powder or dielectric glass, binder, and solvent. On dielectric layer 8, protective layer 9 composed of magnesium oxide (MgO) is formed by vacuum deposition method. As a result, a certain composition (scan electrode 4, sustain electrode 5, light shielding layer 7, dielectric layer 8, protective layer 9) is formed on front glass substrate 3, and front pane 12 is completed.

On the other hand, back panel 10 is formed as follows. First, on back glass substrate 11, a material layer of composition for address electrode 12 is formed by screen printing method of a paste containing silver (Ag) material, or by patterning method by photolithography after forming metal film on entire surface. By baking it at desired temperature, address electrode 12 is formed. On back glass substrate 11 forming address electrode 12, a dielectric paste layer is formed by applying dielectric paste so as to cover address electrode 12 by die coating method or the like. By baking the dielectric paste layer, base dielectric layer 13 is formed. The dielectric paste is a paint containing glass powder or dielectric glass, binder and solvent.

A barrier rib forming paste containing barrier rib materials is applied on base dielectric layer 13, and patterned in specified shape, and a barrier rib material layer is formed, and baked, and barrier rib 14 is formed. The patterning method of barrier rib forming paste applied on base dielectric layer 13 includes photolithography and sand blasting. A phosphor paste containing phosphor materials is applied on base dielectric layer 13 between adjacent barrier ribs 14 and at the side of barrier ribs 14, and baked, and phosphor layer 15 is formed. As a result, back panel 10 having a specified composition member on back glass substrate 11 is completed.

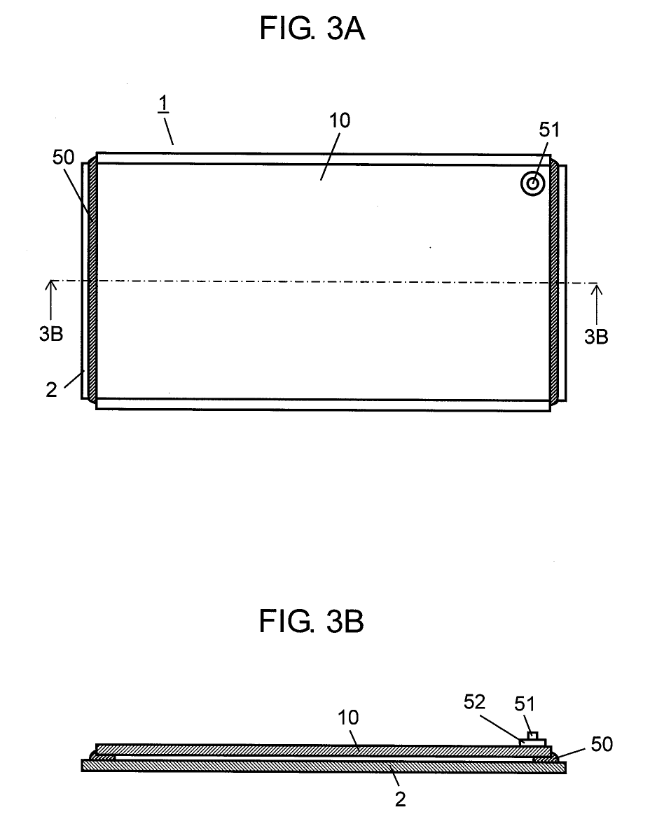

FIG. 3A and FIG. 3B show the sealed and bonded state of front panel 2 and back panel 10 of the PDP in the preferred embodiment of the present invention, in which front panel 2 and back panel 10 are sealed on the surrounding by sealing member 50, and exhaust tube 51 is provided in back panel 10. FIG. 3A is a plan view, and FIG. 3B is a sectional view along line 3B-3B in FIG. 3A.

As shown in FIG. 3A and FIG. 3B, front panel 2 and back panel 10 are disposed face to face so that display electrode 6 and address electrode 12 are orthogonal to each other, and the surrounding is sealed with sealing member 50. After evacuating discharge space 16 through exhaust tube 51, discharge gas containing neon (Ne) or xenon (Xe) is similarly packed in from exhaust tube 51, and exhaust tube 51 is closed, and PDP1 is completed. Frit tablet 52 is intended to fix exhaust tube 51.

Generally, the plasma display is formed of high distortion point glass as represented by PD200 of Asahi Glass Co., and this glass substrate is manufactured usually by float method as mentioned above. In the manufacturing method of the existing float method, when the glass is heated again, if returned to the initial temperature, it tends to have a smaller size than before the treatment. This shrinkage amount varies also with the number of times of baking and the baking temperature.

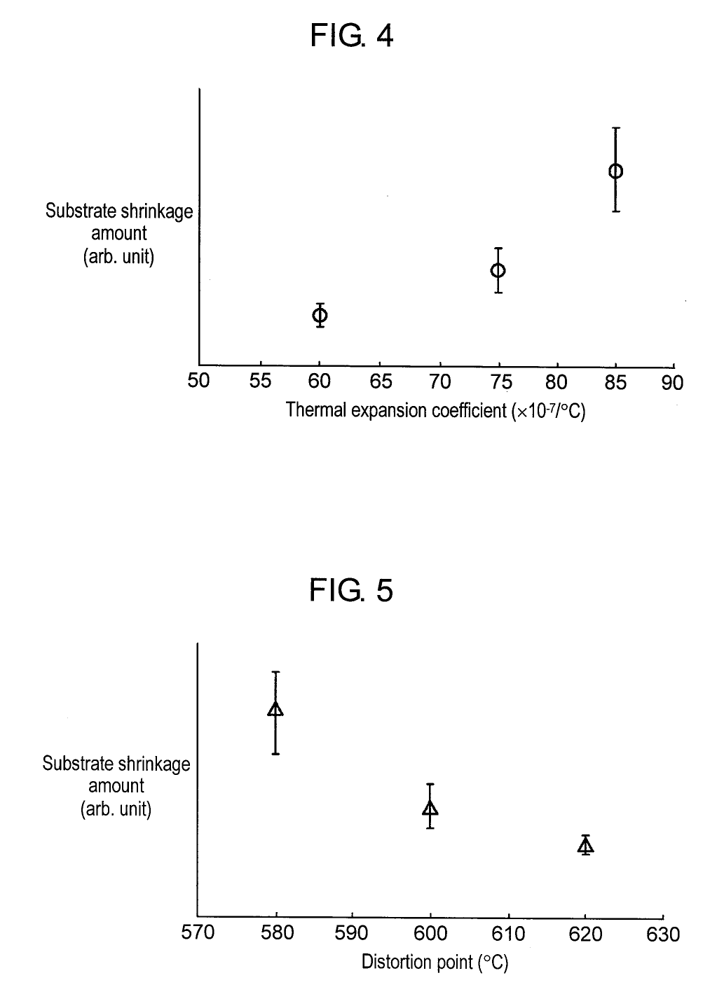

FIG. 4 shows the relation between expansion coefficient of glass substrate and shrinkage amount of the glass substrate. In FIG. 4, the axis of abscissas denotes the thermal expansion coefficient, and the axis of ordinates represents the substrate shrinkage amount. In the present preferred embodiment, the glass substrate lowered in the thermal expansion coefficient is used. In the PD200 of the prior art, the thermal expansion coefficient was 81×10⁻⁷ to 85×10⁻⁷/° C., but in the present preferred embodiment, the thermal expansion coefficient is 60×10⁻⁷ to 75×10⁻⁷/° C. As shown in FIG. 4, by lowering the thermal expansion coefficient, the absolute shrinkage amount of the glass substrate is decreased, and the difference occurring in each glass substrate (hereinafter called the dispersion amount) is also decreased.

In the recent PDP, in the trend of larger screen and high definition, the individual components are demanded to be enhanced in precision, and by decrease of absolute shrinkage amount and dispersion amount of the glass substrate, it is expected to enhance in the production yield.

Thus, by lowering the expansion coefficient of the glass substrate, it is possible to decrease the elongation amount of glass substrate in heat treatment process, and it is also effective to suppress occurrence of damage on the image display surface caused by friction between the glass substrate and the setter used in this process.

Meanwhile, by decreasing the expansion coefficient, the absolute shrinkage amount and the dispersion amount can be suppressed. However, in consideration of dielectric constant or distortion point of the glass substrate described below, the expansion coefficient of the glass substrate is preferred to be 60×10⁻⁷/° C. or more. As the usable range without changing the individual members to be used in the prior art, the expansion coefficient of the glass substrate is preferred to be 65×10⁻⁷ to 75×10⁻⁷/° C.

FIG. 5 shows the relation between distortion point of glass substrate and shrinkage amount of substrate. In FIG. 5, the axis of abscissas denotes the distortion point, and the axis of ordinates represents the substrate shrinkage amount. As show in FIG. 5, as the distortion point of the glass substrate becomes higher, the absolute shrinkage amount and dispersion between substrates can be decreased, and same effects as when the expansion coefficient is lowered may be obtained. However, from the relation between the expansion coefficient and the dielectric constant discussed below, it is preferred to define in a range of 600 to 620° C.

As described above, various glass paste materials are applied, dried and baked on front glass substrate 3 and back glass substrate 11. In the baking process of these heat treatment processes, the glass paste is dissolved and affixed on the glass substrate. It is hence necessary to match and select the expansion coefficient of component members contacting with the glass substrates, such as front glass substrate 3, back glass substrate 11, dielectric layer 8, base dielectric layer 13, barrier rib 14, and sealing member 50. If not matched, the residual distortion increases, and films of members may be peeled, or discharge gas leak or glass cracking may occur.

By matching appropriately, the residual distortion can be decreased, and secondary effects are also obtained, that is, if the treating speed is increased in the heat treatment process, cracking of glass substrate or other defect may not occur, and the production amount can be increased.

Hence, in the present preferred embodiment, the expansion coefficient of dielectric layer 8 is lowered by about 5×10⁻⁷ to 10×10⁻⁷/° C. from the expansion coefficient of the glass substrate, and the dielectric constant is set at about 11.0 or less. The expansion coefficient of sealing member 50 is set at 45×10⁻⁷ to 63×10⁻⁷/° C.

First dielectric layer 81 and second dielectric layer 82 for composing dielectric layer 8 of front panel 2 are specifically described below. The dielectric material of first dielectric layer 81 is composed of the following components. That is, the composition contains 20 wt. % to 40 wt. % of bismuth oxide (Bi₂O₃), and 0.5 wt. % to 15 wt. % of calcium oxide (CaO), and further contains at least one of molybdenum oxide (MoO₃), tungsten oxide (WO₃), cerium oxide (CeO₂), and manganese oxide (MnO₂) by 0.1 wt. % to 7 wt. %.

Further, at least one of strontium oxide (SrO) and barium oxide (BaO) is contained by 0.5 wt. % to 12 wt. %.

Instead of molybdenum oxide (MoO₃), tungsten oxide (WO₃), cerium oxide (CeO₂), and manganese oxide (MnO₂), alternatively, at least one of copper oxide (CuO), chromium oxide (Cr₂O₃), cobalt oxide (Co₂O₃), vanadium oxide (V₂O₇), and antimony oxide (Sb₂O₃) may be contained by 0.1 wt. % to 7 wt. %.

Other components not having lead contents may be also contained, such as 0 wt. % to 40 wt. % of zinc oxide (ZnO), 0 wt. % to 35 wt. % of boron oxide (B₂O₃), 0 wt. % to 15 wt. % of silicon oxide (SiO₂), or 0 wt. % to 10 wt. % of aluminum oxide (Al₂O₃), and the contents of these components are not particularly specified, and may be contained in a range of material composition of the prior art.

The dielectric material composed of such components is pulverized to average particle size of 0.5 μm to 2.5 μm by wet process jet mill or ball mill, and dielectric material powder is prepared. The dielectric material powder, 55 wt. % to 70 wt. %, and the binder component, 30 wt. % to 45 wt. % are kneaded sufficiently by three rolls, and paste for first dielectric layer for die coating or printing is prepared. The binder component is ethyl cellulose, or terpineol containing 1 wt. % to 20 wt. % of acrylic resin, or butyl carbitol acetate. In the paste, as required, a plasticizer may be added, such as dioctyl phthalate, dibutyl phthalate, triphenyl phosphate, or tributyl phosphate, and a dispersant may be also added, such as glycerol mono-olate, sorbitan sesquiolate, homogenol (trade name of Kao Corporation), or ester phosphate of alkyl-allyl group, so that the printing performance may be enhanced.

This first dielectric layer forming paste is applied on front glass substrate 3 so as to cover display electrode 6 by die coating method or screen printing method, and dried, and baked at 575° C. to 590° C., at a temperature slightly higher than the softening point of the dielectric material.

Next, second dielectric layer 82 is explained. The dielectric material of second dielectric layer 82 is composed of the following components. That is, the composition contains 11 wt. % to 40 wt. % of bismuth oxide (Bi₂O₃), and 6.0 wt. % to 28 wt. % of barium oxide (BaO), and further contains at least one of molybdenum oxide (MoO₃), tungsten oxide (WO₃), cerium oxide (CeO₂), and manganese oxide (MnO₂) by 0.1 wt. % to 7 wt. %.

Further, at least one of calcium oxide (CaO) and strontium oxide (SrO) is contained by 0.8 wt. % to 17 wt. %.

Instead of molybdenum oxide (MoO₃), tungsten oxide (WO₃), cerium oxide (CeO₂), and manganese oxide (MnO₂), alternatively, at least one of copper oxide (CuO), chromium oxide (Cr₂O₃), cobalt oxide (Co₂O₃), vanadium oxide (V₂O₇), and antimony oxide (Sb₂O₃) may be contained by 0.1 wt. % to 7 wt. %.

Other components not having lead contents may be also contained, such as 0 wt. % to 40 wt. % of zinc oxide (ZnO), 0 wt. % to 35 wt. % of boron oxide (B₂O₃), 0 wt. % to 15 wt. % of silicon oxide (SiO₂), or 0 wt. % to 10 wt. % of aluminum oxide (Al₂O₃). The contents of these components are not particularly specified, and may be contained in a range of material composition of the prior art.

The dielectric material composed of such components is pulverized to average particle size of 0.5 μm to 2.5 μm by wet process jet mill or ball mill, and dielectric material powder is prepared. The dielectric material powder, 55 wt. % to 70 wt. %, and the binder component, 30 wt. % to 45 wt. % are kneaded sufficiently by three rolls, and paste for second dielectric layer for die coating or printing is prepared. The binder component is ethyl cellulose, or terpineol containing 1 wt. % to 20 wt. % of acrylic resin, or butyl carbitol acetate. In the paste, as required, a plasticizer may be added, such as dioctyl phthalate, dibutyl phthalate, triphenyl phosphate, or tributyl phosphate, and a dispersant may be also added, such as glycerol mono-olate, sorbitan sesquiolate, homogenol (trade name of Kao Corporation), or ester phosphate of alkyl-allyl group, so that the printing performance may be enhanced.

This second dielectric layer forming paste is applied on first dielectric layer 81 by screen printing method or die coating method, and dried, and baked at 550° C. to 590° C., at a temperature slightly higher than the softening point of the dielectric material.

The smaller the film thickness of the dielectric layer 8, the greater is the effect of enhancing the brightness of the panel and decreasing the discharge voltage, and it is desired set the film thickness as small as possible within a range not lowering the dielectric strength. From the viewpoint of such condition and transmittance of visible light, in the preferred embodiment of the present invention, the film thickness of dielectric layer 8 is set at 41 μm or less, and first dielectric layer 81 is defined in a range of 5 μm to 15 μm, and second dielectric layer 82, in a range of 20 μm to 36 μm.

In second dielectric layer 82, when the content of bismuth oxide (Bi₂O₃) is 11 wt. % or less, coloring hardly occurs, but bubble are likely to be formed in second dielectric layer 82, and it is not desired. If exceeding 40 wt. %, coloring tends to occur, and it is not preferred for the purpose of enhancing the transmittance.

It is also required that there is a difference in the content of bismuth oxide (Bi₂O₃) between first dielectric layer 81 and second dielectric layer 82. Otherwise, if the content of bismuth oxide (Bi₂O₃) is same between first dielectric layer 81 and second dielectric layer 82, due to effects of bubbles formed in first dielectric layer 81, bubbles are also formed in second dielectric layer 82 in the baking process of second dielectric layer 82.

When the content of bismuth oxide (Bi₂O₃) in second dielectric layer 82 is smaller than the content of bismuth oxide (Bi₂O₃) in first dielectric layer 81, since second dielectric layer 82 occupies more than half of the total thickness of dielectric layer 8, in addition to the effects discussed above, coloring of metal color hardly occurs, and the transmittance can be enhanced. Besides, since the material of Bi system is expensive, the cost of the raw materials can be saved.

When the content of bismuth oxide (Bi₂O₃) in second dielectric layer 82 is larger than the content of bismuth oxide (Bi₂O₃) in first dielectric layer 81, since the softening point of second dielectric layer 82 can be lowered, removal of bubbles in the baking process may be enhanced.

The PDP manufactured in this manner is small in coloring phenomenon (yellowing) of front glass substrate 3 if silver (Ag) material is used in display electrode 6, and bubbles are hardly generated in dielectric layer 8, and dielectric layer 8 excellent in dielectric strength performance is realized.

In the PDP of the preferred embodiment of the present invention, the reason of suppression of yellowing or bubbles in first dielectric layer 81 made of such dielectric materials is discussed. That is, by adding molybdenum oxide (MoO₃) or tungsten oxide (WO₃) to the dielectric glass containing bismuth oxide (Bi₂O₃), compounds such as Ag₂MoO₄, Ag₂Mo₂O₇, Ag₂Mo₄O₁₃, Ag₂WO₄, Ag₂W₂O₇, or Ag₂W₄O₁₃ are likely to be formed at low temperature 580° C. or less. In the preferred embodiment of the present invention, since the baking temperature of dielectric layer 8 is 550° C. to 590° C., the silver ions (Ag⁺) diffused in dielectric layer 8 during baking react with molybdenum oxide (MoO₃), tungsten oxide (WO₃), cerium oxide (CeO₂), or manganese oxide (MnO₂) in dielectric layer 8, and produce stable compounds. That is, silver ions (Ag⁺) are stabilized without being reduced, and do not aggregate to form colloid. Therefore, since silver ions (Ag⁺) are stabilized, generation of oxygen accompanying colloid forming of silver (Ag) is less, and generation of bubbles in dielectric layer 8 is decreased.

On the other hand, to make these effects more effective, in the dielectric glass containing bismuth oxide (Bi₂O₃), it is desired to add 0.1 wt. % or more of molybdenum oxide (MoO₃), tungsten oxide (WO₃), cerium oxide (CeO₂), or manganese oxide (MnO₂), or more preferably 0.1 wt. % or more to 7 wt. % or less. If less than 0.1 wt. %, there is no effect of suppressing yellowing, or if more than 7 wt. %, coloring may occur in the glass.

By adding calcium oxide (CaO) to first dielectric layer 81, in the baking process of first dielectric layer 81, calcium oxide (CaO) acts as an oxidizing agent to promote removal of binder components remaining in the electrode. On the other hand, second dielectric layer 82 contains barium oxide (BaO), which is effective to improve the transmittance of second dielectric layer 82.

That is, in dielectric layer 8 of the PDP in the preferred embodiment of the present invention, first dielectric layer 81 contacting with metal bus electrodes 4b, 5b formed of silver (Ag) material suppresses the yellowing and bubbling, and second dielectric layer 82 provided on first dielectric layer 81 realizes a high light transmittance. As a result, dielectric layer 8, on the whole, realizes a PDP extremely small in occurrence of bubbles or yellowing, and high in transmittance.

Next, in the PDP of the preferred embodiment of the present invention, the material composition of sealing member 50 and a sealing method are explained. In the present preferred embodiment, in order to keep air tightness as panel container by suppressing residual distortion of component members, the expansion coefficient of sealing member is defined at 45×10⁻⁷ to 63×10⁻⁷/° C., in comparison with the expansion coefficient of 60×10⁻⁷ to 75×10⁻⁷/° C. of front glass substrate 3 and back glass substrate 11.

Sealing member 50 is coated with, at least on the peripheral edge of either back panel 10 or front panel 2, a glass material containing at least bismuth oxide (Bi₂O₃), molybdenum oxide (MoO₃), or tungsten oxide (WO₃), and a sealing composition paste containing heat-resistant filler and organic binder component. Then, after drying for a specific time, the organic binder component is burnt and removed by calcining at about 400° C. Both substrates are disposed face to face so that display electrode 6 group of front panel 2 and address electrode 12 of back panel 10 may be orthogonal to each other, and sealing member 50 is baked at 450° C. to 480° C., and solidified.

The composition of the sealing member is specified by the glass component of glass softening point of 410° C. or more, containing at least 75 wt. % or more of bismuth oxide (Bi₂O₃), and 0.2 wt. % or more of molybdenum oxide (MoO₃) or tungsten oxide (WO₃). In a more preferred glass composition, bismuth oxide (Bi₂O₃) is contained by 75 wt. % to 85 wt. %, zinc oxide (ZnO) by 5.6 wt. % to 18 wt. %, boron oxide (B₂O₃) by 2 wt. % to 9 wt. %, aluminum oxide (Al₂O₃) by 0.2 wt. % to 1.1 wt. %, at least one of calcium oxide (CaO), strontium oxide (SrO) and barium oxide (BaO) by 0.1 wt. % to 1 wt. %, and at least one of molybdenum oxide (MoO₃) and tungsten oxide (WO₃) by 0.2 wt. % to 5 wt. %. If the content of bismuth oxide (Bi₂O₃) is less than 75 wt. %, the softening point of glass is hardly lowered as expected, and sealing is not sufficient, or if more than 85 wt. %, the reaction is sever between display electrode 6 and silver (Ag) in address electrode 12, and bubbles are likely to be formed.

The heat-resistant filler is used for adjusting the thermal expansion coefficient of sealing member 50, and controlling the fluid state of glass, and is preferably composed of cordierite, forsterite, β-euclyptite, zircon, mullite, barium titanate, aluminum titanate, titanium oxide, molybdenum oxide, tin oxide, aluminum oxide, or quartz glass.

When the sealing member composed of such glass components is used, same as discussed in the explanation of the dielectric layer, by adding molybdenum oxide (MoO₃) or tungsten oxide (WO₃), a stable compound is formed in the baking process of sealing member 50 by reacting with silver ions (Ag⁺) in display electrode 6 or address electrode 12. As a result, silver ions (Ag⁺) are stabilized, and generation of oxygen accompanying colloid forming of silver (Ag) is less, and generation of bubbles in sealing member 50 is decreased, and airtight sealing is realized. In particular, in the high definition television and high definition PDP having the number of scanning lines more than two times of the prior art, the effects of the present invention are particularly prominent because the number of electrodes is increased, and a PDP of high reliability is realized.

In the preferred embodiment, exhaust tube 51 or frit tablet 52 shown in FIG. 3 for fixing exhaust tube 51 to back glass substrate 11 may be also made of same material as sealing member 50. When exhaust tube 51 is made of similar material, sealing member 50, exhaust tube 51, and frit tablet 52 can be made of material not containing lead (Pb) and free from impact on environment.

In the present preferred embodiment, the PDP was manufactured by using front glass substrate 3, back glass substrate 11, dielectric layer 8, and sealing member 50 as described herein, and was compared with the conventional PDP in the following experiment. In the experiment, the discharge cell was manufactured to conform to Hi-Vision television of 42-inch class, and the height of barrier rib 14 was 0.15 mm, the interval (cell pitch) of barrier rib 14 as 0.15 mm, the electrode-to-electrode distance of display electrode 6 was 0.06 mm, the material composition of sealing member 50 was varied, and the PDP was manufactured by packing with mixed gas of Ne—Xe system with content of xenon (Xe) of 15 vol. %, at sealing pressure of 60 kPa. From each product, 100 samples were manufactured, the residual distortion near the sealing member was measured, and defective rates of air tightness were compared. In air tightness test, front panel 2 and back panel 10 were sealed with the sealing member, and after continuous discharge for 100 hours, it was judged whether leakage in discharge space occurred or not.

As a result, in the PDP of the present preferred embodiment, as compared with the PDP of the prior art, the residual distortion was decreased, and number of defects of air tightness was decreased. At the same time, damages of the image display surface were reduced, and the production yield was enhanced.

The following effects were also confirmed in the present preferred embodiment. The AC type PDP applies voltages between scan electrode 4 and sustain electrode 5 in its driving operation for image display, and generates discharge called sustain discharge mainly responsible for image luminance. Sustain discharge is a discharge occurring in the discharge space, caused by an electric field occurring in the plane between the surface of protective layer 9 on scan electrode 4 through dielectric layer 8, and the surface of protective layer 9 on sustain electrode 5 through dielectric layer 8.

In the AC type PDP, in order to continue this sustain discharge, voltages are applied alternately to scan electrode 4 and sustain electrode 5. Applied voltages are pulse voltages of square wave, and since dielectric layer 8 has a certain electrostatic capacity, working as a capacitor, by applying voltages alternately, a charging and discharging current is always flowing in the capacitor.

However, such charging and discharging current to the capacitor is a reactive current, not contributing directly to light emission as image display. As a result, a loss occurs in the resistance component of scan electrode 4 or sustain electrode 5 or in the control circuit, and a reactive power occurs. At higher resolution, moreover, the number of display electrodes increases, and the increase of reactive power is more obvious, the power consumption increases, and the efficiency of light emission cannot be improved sufficiently.

By contrast, by decreasing the electrostatic capacity, the reactive current can be suppressed and the power consumption can be lowered. When the countermeasure is considered from the viewpoint of the capacitor, by increasing the film thickness of dielectric layer 8, the capacity can be made smaller. In the case of AC type PDP, however, as mentioned above, the discharge is in-plane discharge, that is, the sustain electrode and scan electrode are on the same plane. Accordingly, the capacity relating to the reactive power does not rely so much on the film thickness, and it is most closely related to the vicinity of forming the scan electrode and sustain electrode, that is, the dielectric constant of front glass substrate 3 and dielectric layer 8.

In the present preferred embodiment, also in this regard, the dielectric constant of front glass substrate 3 and dielectric layer 8 is set lower than in the prior art. Specifically, in front glass substrate 3, the dielectric constant of about 7.6 in the prior art is lowered to 7.0 or less, and in dielectric layer 8, the dielectric constant of about 13.0 in the prior art is lowered to 11.0 or less. As a result, in the experiment, the reactive power was substantially decreased. The dielectric constant of the glass substrate is preferred to be 5.0 or more in relation to the expansion coefficient and distortion point, and similarly the dielectric constant of dielectric layer 8 is preferred to be 5.0 or more.

As described herein, the PDP of the present invention is a plasma display panel composed of a pair of substrates having a dielectric layer at least on one side, disposed face to face, and sealed with a sealing member on the surrounding, in which the expansion coefficient of the pair of substrates is 75×10⁻⁷/° C. or less, and the expansion coefficient of the sealing member is 45×10⁻⁷ to 63×10⁻⁷/° C., and the dielectric constant of the substrate is 5.7 to 7.0, and the expansion coefficient of the sealing member is 45×10⁻⁷ to 63×10⁻⁷/° C., and the distortion point of the substrate is 600° C. or more, and the expansion coefficient of the sealing member is 45×10⁻⁷ to 63×10⁻⁷/° C. Therefore, even though it is high definition display, a high reliability is assured and the productivity is enhanced, and the PDP in consideration of environmental problems can be realized.

### INDUSTRIAL APPLICABILITY

As described herein, the PDP of the present invention is a PDP enhanced in reliability of sealing, free from load on environment, and excellent in display quality, and it is very useful for a display device of a large screen.

1. A plasma display panel comprising:
a pair of substrates disposed face to face and having a dielectric layer at least at one side, and sealing their surroundings with a sealing member,
wherein an expansion coefficient of the pair of substrates is 60×10⁻⁷ to 75×10⁻⁷/° C., and
an expansion coefficient of the sealing member is 45×10⁻⁷ to 63×10⁻⁷/° C.

2. A plasma display panel comprising:
a pair of substrates disposed face to face and having a dielectric layer at least at one side, and sealing their surroundings with a sealing member,
wherein a dielectric constant of the pair of substrates is 5.7 to 7.0, and
an expansion coefficient of the sealing member is 45×10⁻⁷ to 63×10⁻⁷/° C.

3. A plasma display panel comprising:
a pair of substrates disposed face to face and having a dielectric layer at least at one side, and sealing their surroundings with a sealing member,
wherein a distortion point of the pair of substrates is 600° C. or more, and
an expansion coefficient of the sealing member is 45×10⁻⁷ to 63×10⁻⁷/° C.

4. The plasma display panel of claim 1,
wherein the sealing member includes at least one of bismuth oxide, molybdenum oxide, and tungsten oxide as a glass component.

5. The plasma display panel of claim 2,
wherein the dielectric constant of the dielectric layer is 5.0 to 11.0.

6. The plasma display panel of claim 2,
wherein the sealing member includes at least one of bismuth oxide, molybdenum oxide, and tungsten oxide as a glass component.

7. The plasma display panel of claim 3,
wherein the sealing member includes at least one of bismuth oxide, molybdenum oxide, and tungsten oxide as a glass component.
